(19) United States
(12) Patent Application Publication
(10) Pub. No.: US 2014/0324712 A1
(43) Pub. Date: Oct. 30, 2014

(54) METHOD AND APPARATUS FOR ENTERING INTO A CONTRACT

(71) Applicant: Paul Vacquier, Manhattan Beach, CA (US)

(72) Inventor: Paul Vacquier, Manhattan Beach, CA (US)

(21) Appl. No.: 13/873,096

(22) Filed: Apr. 29, 2013

(51) Int. Cl. G06Q 50/18; G06Q 10/10

(52) U.S. Cl. CPC G06Q 50/18; G06Q 10/10
USPC 705/311

(57) ABSTRACT

A method and apparatus for entering into a contract is disclosed. The method being implemented by a user computing device having one or more processors and a display, the method including selectively displaying content corresponding to one or more terms of the contract on the display for a user to view, and prompting the user to generate a recording of the user audibly reading the displayed content.

### TECHNICAL FIELD

Examples described herein pertain generally to a system and method for entering into a contract through use of computing devices.

### BACKGROUND

Unilateral contracts provide a convenient way for parties to enter into legally binding agreements. While a bilateral agreement involves promises from each party to the other, a unilateral agreement involves a promise from just one party. Examples of such contracts include certain investment contracts, liability waiver agreements, and the like.

In many situations, enforcing a unilateral agreement in litigation involves proving that a given party assented to the agreement. Evidence of assent is often found by obtaining an original or authenticated signature to a written document that sets out the terms of the agreement in detail. While this provides a form of evidence that a party who signed the document “assented” to the terms of the agreement, there still may be issues in proving that the party actually understood the key terms of the agreement when signing the agreement. This often leads to further discovery in litigation, increasing the costs to the litigants and minimizing the predictability of a successful outcome.

### BRIEF DESCRIPTION OF THE DRAWINGS

FIG. 1 illustrates one embodiment of a contract management system that enables a party to enter into a contract through use of a computing device.

FIG. 2 illustrates one embodiment of a graphical user interface (GUI) screen for display by with the computing device of FIG. 1.

FIG. 3 illustrates a further GUI screen having selectable agreement content for display by the computing device of FIG. 1.

FIG. 4 is a view of a display associated with the computing device of FIG. 1 that shows a user video image and a selected agreement content overlaid on the video image.

FIG. 5 is a flowchart of steps associated with one embodiment of a method for entering into a contract utilizing the computing device of FIG. 1.

FIG. 6 is a flowchart of steps associated with one embodiment of a method for accessing an agreement recording previously uploaded to the contract management platform of FIG. 1.

### DETAILED DESCRIPTION

Examples described herein provide a system and computer-implemented method for entering into a contract. The method may be implemented by a user mobile computing device having one or more processors and a display. The user computing device selectively displays content corresponding to one or more terms of the contract on the display for a user to view. While viewing, the user is also prompted to generate a recording while the user audibly reads the displayed content. By having a user audibly read the terms of an agreement while being recorded, evidence of assent may be more easily shown or proved in a contract dispute that involves the user. Having such evidence readily available at a future time may significantly reduce litigation costs and improve risk assessment accuracy.

According to an example, the recorded content may then be uploaded onto a contract management platform until retrieved at a later date by a party seeking to prove assent to the contract.

In some examples, the recording may be an audio recording of the user reading the terms of the agreement. In other embodiments, the recording may be a video recording of the user reading the terms of the agreement.

According to a further embodiment, a system is disclosed that includes a website having a download interface to download software that, when executed by one or more processors in a mobile computing device, cause the one or more processors to selectively display content corresponding to one or more terms of a contract on a display for a user to view. The user may then be prompted to generate a recording of the user audibly reading the displayed one or more terms, and also annunciating assent to the terms. An upload link allows access to web-based storage to store the recording for archiving and future retrieval.

In a further embodiment, a non-transitory computer-readable medium is disclosed that stores instructions that, when executed by one or more processors, cause the one or more processors to selectively display text corresponding to one or more terms of a contract on a mobile computing device display for a user to view. A user may be prompted to generate a recording of the user audibly reading the displayed one or more terms.

As used herein, a “contract” may refer to a unilateral or bilateral agreement. Also as used herein, a “user” may refer to an individual operating a computing device. An example of a user may include a party to the contract, or an administrator working on behalf of a party to the agreement, or an independent third party having no interest in the agreement other than to see that assent to the contract is recorded and uploaded to the contract management platform described herein.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component may include a program, a sub-routine, a portion of a program, or a software component or a hardware component capable of performing one or more stated tasks or functions. As used herein, a module or component may exist on a hardware component independently of other modules or components. Alternatively, a module or component may be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

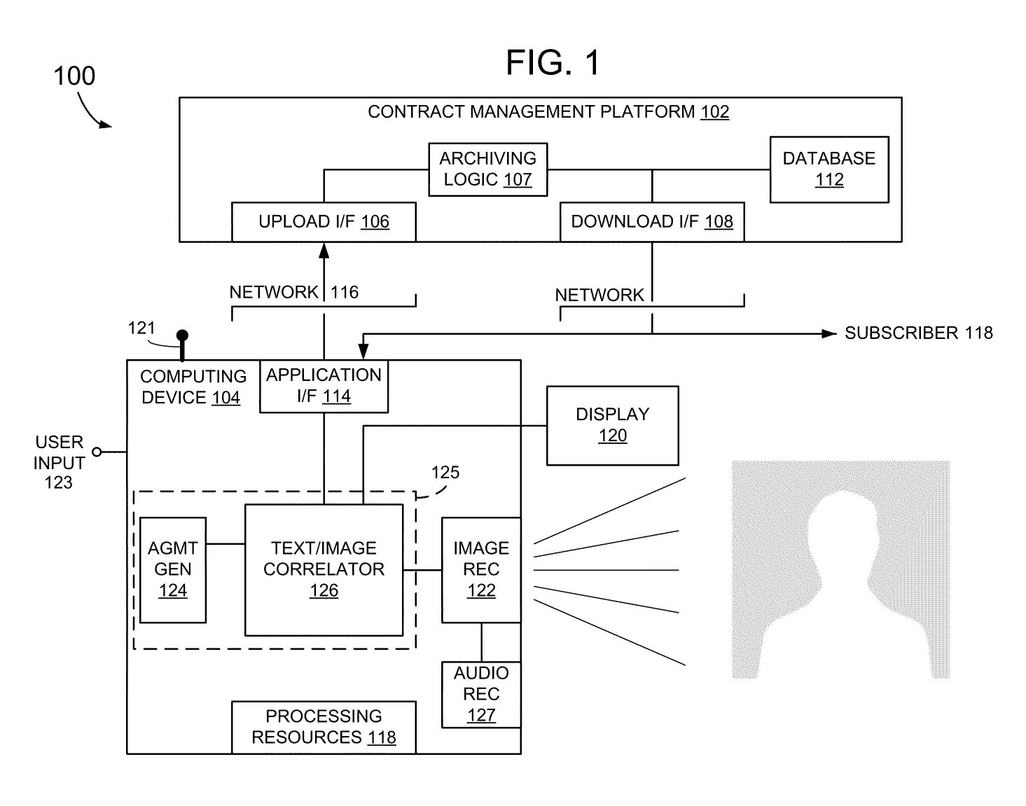

FIG. 1 illustrates an example system, generally designated 100, that manages the generation and archival of agreements entered into by various parties. According to some examples, the system 100 can be implemented through software that operates on various computing platforms, such as a general-purpose computer, a web-based server, and/or mobile computing device. System 100 can also be implemented through other computer systems in alternative architectures (e.g., peer-to-peer networks, etc.).

In one example, the system 100 includes a contract management platform 102 that provides a repository to archive contracts that have been entered into via software resident on a computing device 104 and according to a unique method more fully described below. The platform 102 generally includes an upload interface 106 to receive content such as approved and/or customized contracts and recordings. A download interface 108 dispatches selected content such as recordings to platform subscribers 118 or custom contracts to the application interface 114 when selected by the user.

With continued reference to FIG. 1, the contract management platform employs archive logic 107 that interacts with the upload interface 106 to apply a time stamp to received content. The archive logic 107 may also assign an identifier and title to the received content. The identifier may take the form of a token that may be associated with a given subscriber, or subscriber computing device, associated with a party to the contract recorded in the received content. The token also enables streamlined access to the agreement at a future time and user identification and authentication. The title applied by the archive logic 107 may correspond to the type of contract that is associated with the recorded content. A searchable database 112 is accessible by both the upload and download interfaces 106 and 108 and stores the recorded content in accordance with subscriber policies.

For one embodiment, the contract management platform 102 is realized as a web-based service independent from any contracting party. The platform provides its archiving services in return for subscriber fees. As subscribers sign up, they select the types of agreements that match their business and/or personal needs, and authorize the platform to simplify the agreements to a bullet-point format. As subscribers download the software application for use on their computing device, the pre-set agreement terms authorized as “approved products” are downloaded to the computing device 104 along with the rest of the software.

Further referring to FIG. 1, one embodiment of the computing device 104 may correspond to a mobile computing device, such as a cellular device that is capable of telephony, messaging, and data services. Examples of such devices include smartphones, handsets or tablet devices for cellular carriers. The mobile computing device includes processing resources 118 that may include a processor and associated memory resources. The computing device also includes a display device 120 (e.g., such as a touch-sensitive display device), one or more communication sub-systems 121 (including wireless communication sub-systems), input mechanisms 123 (e.g., an input mechanism can include or be part of the touch-sensitive display device), an image recorder, such as a still and/or video camera component 122, and an audio recorder 127 that may be separate from or embedded in the video camera component. In one example, at least one of the communication sub-systems 121 sends and receives cellular data over data channels and voice channels.

Further referring to FIG. 1, one embodiment of the mobile computing device includes an application interface 114 that selectively communicates with the platform upload interface 106 via a wireless network connection 116. In some embodiments, a user of the mobile computing device downloads an application 125 in the form of software that enables the mobile computing device 104 to carry out certain functions more fully described below. In one embodiment, the application 125 may be provided to an authorized “App” seller for the user to purchase and download to the computing device.

With continued reference to FIG. 1, in one embodiment, the application 125 includes an agreement generator 124 to produce content corresponding to a selectable contract, and a text/image correlator 126 to tie the selected contract to recorded content. The agreement generator 124 interacts with storage in the mobile computing device to store one or more pre-set template agreements for selection by a user. The text/image correlator 126 generates a displayable overlay of the content produced by the agreement generator for presentation onto a display screen 120. The overlay is accomplished such that a user looking into the display screen can see a video self-image and the contract terms overlaid onto the recorded image.

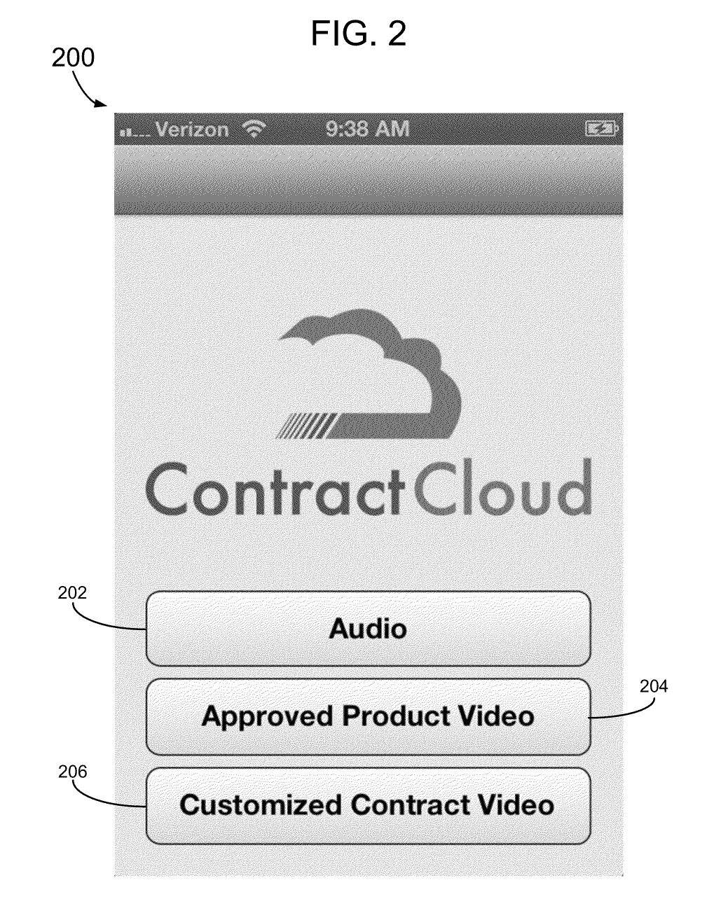

The processing resources 118 are configured with software and/or other logic to perform one or more processes, steps and other functions described with implementations, such as described by FIGS. 1 through 6, and elsewhere in the application. The processing resources 118 may be configured, with instructions and data stored in memory, to operate, for example, a contract formation application as described in FIGS. 1 through 6. For example, instructions for operating the contract formation application to display various user interfaces, such as described in FIGS. 2 through 4, can be stored in the processing resources 118 of the computing device 104. In one implementation, a user can operate the contract formation application to enter into a contract. In some implementations, the user can interact with the touch-sensitive display device 120 to make selections that are provided with one or more user interfaces and/or instructions.

In some examples, the user can operate (e.g., through use of the contract formation application) the camera component 122 to provide image data that is to be recorded for purposes of documenting existence of the contract. For example, one or more of the instructions that are presented to the user can instruct the user to take a self-image as the user reads the terms of an agreement. The camera component 122 can provide image data that corresponds to the user reading the terms of a contract that is being displayed on the display device 120. The generated recording can be provided to the communication sub-systems 121 to be transmitted or linked to the contract management platform 102. The communication sub-systems 121 can enable the computing device 104 to communicate with other servers and computing devices, for example, over the network 116 (e.g., wirelessly or using a wireline). While FIG. 1 is illustrated for a mobile computing device, one or more examples may be implemented on other types of devices, including full-functional computers, such as laptops and desktops (e.g., PC).

FIG. 2 illustrates one embodiment of an initial selection screen 200 that forms a portion of the overall graphical user interface (GUI) that is generated by the application software. The screen is made available for display to a user after opening the application and prompts the user for the type of recorded content to be generated. In one embodiment, the display screen provided by the mobile computing device is a touchscreen that allows a user to make selections merely by touching a designated spot on the screen. Consistent with this touchscreen functionality, a first user selection button 202 provided by the application offers an “Audio” choice for the user, which results in an audio-only recording of the agreement as a user reads terms displayed on the display device.

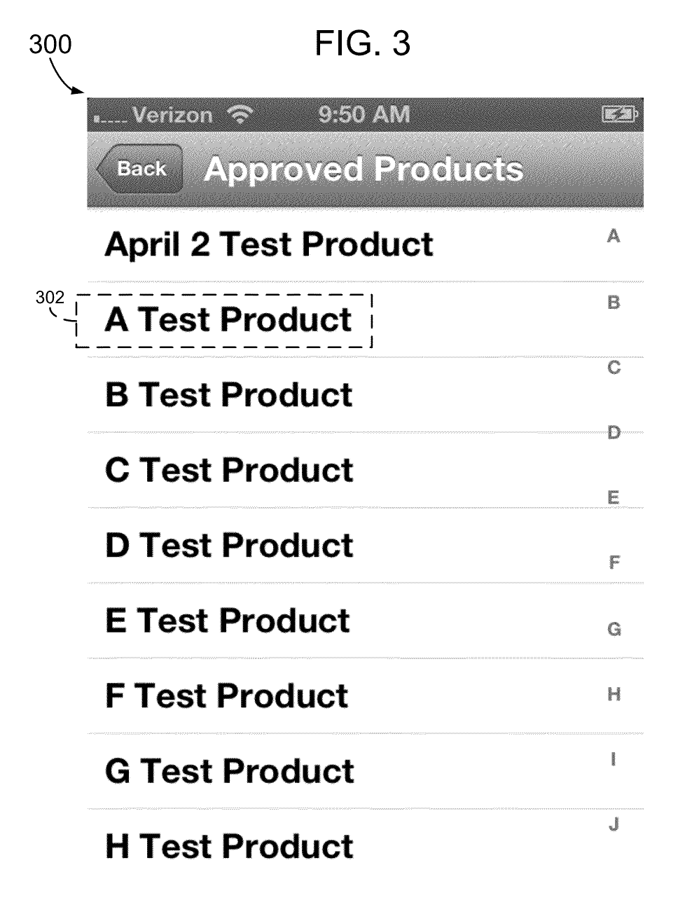

Further referring to FIG. 2, a second selection button 204 enables a user to designate the recorded content as being related to an “Approved Product Video.” In some embodiments, as shown in FIG. 3, the approved products may be one or more pre-set template agreements 302 listed in a further user interface screen 300, for selection by the user. In one embodiment, each pre-set template includes high-level terms set out in bullet-point format to greatly simplify the wording of the agreement and improve the user's understandability of the contract.

Referring back to FIG. 2, a further option button 206 allows a user to select a “Customized Contract Video” that allows for a separate download of a customized set of contract terms from the contract management platform for overlay on the video image of the user. Such an option allows for straightforward agreements between parties such as a generic liability waiver or an agreement for the sale of personal property (such as a car, guitar, etc.).

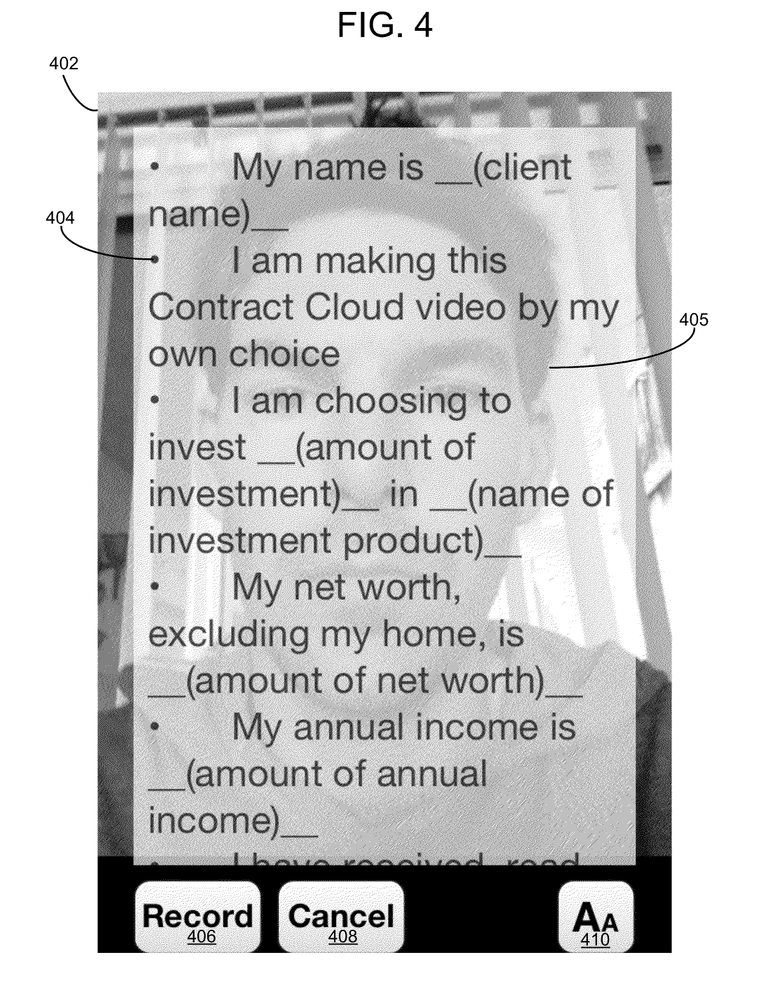

Once a given recording selection is made from the previously described user interface screens, the mobile computing device display screen may be activated to display the selected contract terms, and the recording device enabled to record either audio or both audio and video content. In the case of video content, one embodiment allows the user to view a self-image from the display while reading the terms of the agreement overlaid on the self-image. FIG. 4 illustrates a mobile computing device display screen 400 with bullet-point terms 404 overlaid onto the display screen with a user image 404 shown in the background. A “Record” touch button 406 is provided to enable the user to control when to record. A “Cancel/Stop” button 408 is also provided to restart the contract selection process and return the user to the list of approved contracts. To adjust a font size of the overlaid text on the display, a font button 410 is provided. In some embodiments, the font size may be adjusted by dragging the user's fingers in a pinching motion on the touch screen. Once the font size is set, and the user's face is centered in the display, the user may activate the record button and begin reciting the terms of the displayed agreement. For some embodiments, the “Record” button may pulse in a red color to indicate to the user that a recording is actually taking place, and the “Cancel” button becomes a “Stop” button. As the last visible bullet point is read from the screen, the user may scroll the text further down to display further terms such as, for example, touching and dragging the screen in a downward direction. Once the terms are read out in full, the “Stop” button may be touched to stop the recording, with the screen displaying confirmation that the video recording is complete. The user may then be prompted with an option to either “Upload”, “Re-record”, or “Cancel Recording.”

Following the successful recording of content, the content designated for uploading may be transferred to the contract management platform 102. In one embodiment, the uploading occurs automatically after the recording is complete. For other embodiments, a user may wish to manually upload the content at a later time.

Methodology

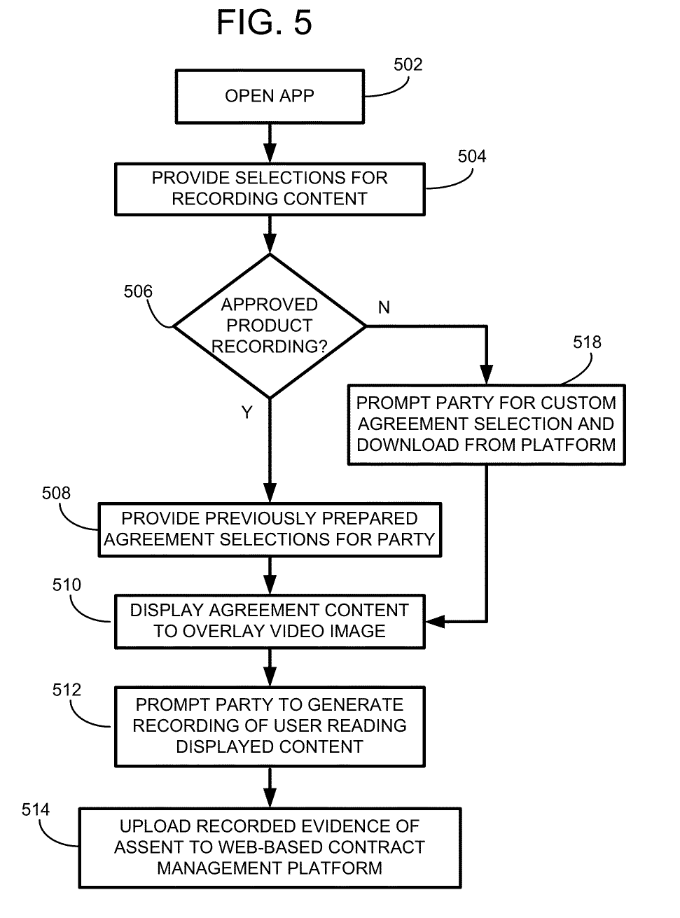

FIG. 5 illustrates an example method for entering into a contract, generally designated 500. A method such as described by an embodiment of FIG. 5 may be implemented using, for example, components and software described with the system embodiment of FIG. 1. Accordingly, references made to elements of FIG. 1 are for purposes of illustrating a suitable element or component for performing a step or sub-step being described.

In FIG. 5, a user begins the process of entering into a contract by opening the mobile computing device software application, at 502. For one specific embodiment, the agreement may be an investment agreement often offered by financial institutions to investor clients. The agreement may be unilateral in nature, such that the agreement may be entered into, or formed by one party, such as the client. The software may be readily adaptable for contract formation relating to other types of contracts as well, including bilateral contracts.

Once the application is opened, the software user interface prompts the user by providing a variety of selections, such as those shown in FIG. 3, for the type of recorded content that is desired, at step 504. Again, as an example, the recorded content may be audio only, a video recording associated with previously approved agreements, or a video recording for a customized agreement. Once a selection is made, a determination is carried out by the software as to whether the user selected an approved product recording, at 506. If so, then a new user interface page may be presented to the user, similar to that shown in FIG. 4, to display previously prepared agreement selections as choices for the user, at 508. In the event the user selects a non-approved product recording, such as audio-only or a custom recording, then the software prompts the user for the desired custom agreement selection for download from the contract management platform, at 518.

Further referring to FIG. 5, following selection of the agreement content, the computing device 102 displays the selected content on the display screen, at 510. Once the agreement content is displayed, the software may prompt the user to generate a recording of the user reading the displayed content, at 512. As explained earlier, the recording may be audio-only, or audio/video. In one embodiment, the display screen displays a video image of the user, and the displayed content is overlaid with the video content. In this manner, the user may orient the computing device display to generate a self-image, with the agreement context also displayed to enable the user to view the camera directly while reading the content during the recording of the self-image.

Following completion of the recording, the recorded evidence of assent may then be uploaded to the contract management system 102, at 514.

Once the recorded content is uploaded to the contract management platform, the archive logic 107 may apply a time stamp representing the date and time of the upload, an identifier such as a token to associate the content with a given subscriber, and a title representing the type of contract being uploaded (such as a type of approved product shown in the listing of FIG. 3). The labeled content may then be stored for future retrieval.

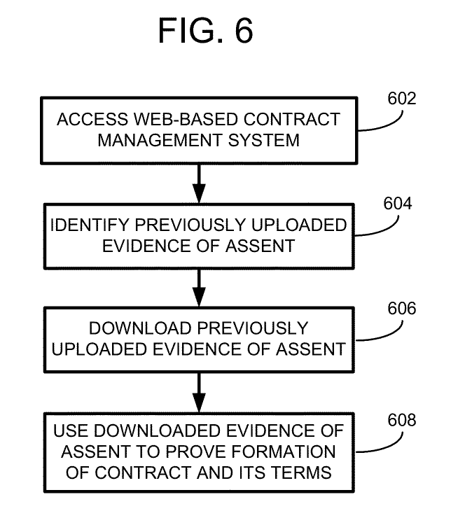

In the event that a dispute arises involving the contract, a subscriber may request a copy of the stored content. FIG. 6 illustrates a flowchart that sets forth steps carried out in a method to retrieve previously uploaded content from the contract management platform 102. Subscribers who have paid a fee to the provider of the platform may access the contract management platform consistent with their subscriber privileges, at 602. The platform database may then be searched in accordance with identified search criteria, such as by token identifier and/or content title, to locate recorded content, at 604. Results of the search may then be downloaded to the subscriber, at 606. With the recorded content readily available to the subscriber, who is most likely a party to a dispute involving the contract, the content may be used as evidence that the user whose image and voice was recorded reciting the terms of the contract understood and assented to the terms of the contract.

Those skilled in the art will appreciate that the embodiments described herein provide a straightforward way to enter into or form a contract using readily available computing devices, such as mobile smartphones or other computing devices with displays and recording capabilities. Evidencing assent to a given contract by recording a party reading the terms of the agreement, and storing the recording on an independent third party platform provides a level of authenticity to the recorded evidence that may significantly reduce litigation costs and improve risk assessment capabilities for companies that regularly become parties to such contracts.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the invention is not limited to those precise examples. As such, many modifications and variations will be apparent to practitioners skilled in this art. Accordingly, it is intended that the scope of the invention be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

What is claimed is:

1. A computer-implemented method for entering into a contract, the method being implemented by a user computing device having one or more processors and a display, the method comprising:
selectively displaying content corresponding to one or more terms of the contract on the display for a user to view;
prompting the user to generate a recording of the user audibly reading the displayed content, the recording carried out by the computing device.

2. The method of claim 1, further comprising:
uploading the recording to a website that is independent from any party to the contract.

3. The method of claim 1, wherein prompting the user to generate a recording comprises prompting the user to generate an audio recording.

4. The method of claim 1, wherein prompting the user to generate a recording comprises prompting the user to generate a video image to form the basis for a video recording.

5. The method of claim 4, further comprising:
overlaying the content corresponding to one or more terms of the contract on the video image.

6. The method of claim 1, wherein selectively displaying text comprises:
providing a selection of modes for selection by the user; and
displaying the text based on the user selection.

7. The method of claim 6, wherein a first user mode in the selection of modes comprises an automatic sequence including displaying terms from one from a selection of predetermined agreements, and recording a user reading the displayed terms.

8. The method of claim 7, wherein a second user mode in the selection of modes includes an automatic sequence including displaying terms from a customized agreement, and recording a user reading the displayed terms.

9. The method of claim 2, further comprising:
after uploading the recording to the independent website, making the recording available to a selected party to evidence assent to the contract.

10. A system comprising:
a website having a download interface to download software that, when executed by one or more processors in a computing device, cause the one or more processors to:
selectively display content corresponding to one or more terms of a contract on a display for a user to view;
prompt the user to generate a recording of the user audibly reading the displayed one or more terms; and
an upload link for accessing web-based storage, the web-based storage for storing the recording.

11. The system of claim 10, wherein the recording is selectively retrievable as evidence of assent to the contract.

12. A non-transitory computer-readable medium storing instructions that, when executed by one or more processors, cause the one or more processors to:
selectively display text corresponding to one or more terms of a contract on a computing device display for a user to view; and
prompt a user to generate a recording of the user audibly reading the displayed one or more terms.

13. The non-transitory computer-readable medium of claim 12, wherein the instructions further cause the one or more processors to:
upload the recording to a website that is independent from any party to the contract.

14. The non-transitory computer-readable medium of claim 12, wherein the instructions to prompt a user to generate a recording cause the one or more processors to:
prompt the user to generate an audio recording of the user reading the displayed one or more terms.

15. The non-transitory computer-readable medium of claim 12, wherein the instructions to prompt a user to generate a recording cause the one or more processors to:
prompt the user to generate a video image to form the basis for a video recording of the user reading the displayed one or more terms.

16. The non-transitory computer-readable medium of claim 15, wherein the instructions further cause the one or more processors to:
overlay the text corresponding to one or more terms of the contract on the video image.

17. The non-transitory computer-readable medium of claim 12, wherein the instructions further cause the one or more processors to:
provide a selection of modes for selection by the user; and
display the text based on the user selection.

18. The non-transitory computer-readable medium of claim 17 wherein a first user mode in the selection of modes comprises an automatic sequence including displaying terms from one from a selection of predetermined agreements, and recording a user reading the displayed terms.

19. The non-transitory computer-readable medium of claim 18 wherein a second user mode in the selection of modes includes an automatic sequence including displaying terms from a customized agreement, and recording a user reading the displayed terms.

20. The non-transitory computer-readable medium of claim 14, wherein the instructions further cause the one or more processors to:
after uploading the recording to the independent website, make the recording available to a selected party to evidence assent to the contract.

21. The non-transitory computer-readable medium of claim 18 wherein each page is sequenced following input provided by the user.
